(19) United States
(12) Patent Application Publication
(10) Pub. No.: US 2005/0044872 A1
(43) Pub. Date: Mar. 3, 2005

(54) Tubular element for an air-conditioning circuit

(75) Inventors: Marc Tourte, Villemandeur (FR); Jean-Philippe Lemoine, Amilly (FR)

Correspondence Address: Michael Best & Friedrich LLP, 100 East Wisconsin Avenue, Milwaukee, WI, 53202-4108, US

(73) Assignee: Hutchinson, Paris (FR)

(21) Appl. No.: 10/891,436

(22) Filed: Jul. 14, 2004

(30) Foreign Application Priority Data
Jul. 15, 2003 (FR) 0308599

(51) Int. Cl. F16L 9/18; F16L 11/00; F25D 19/00

(52) U.S. Cl. 62/298; 138/115

(57) ABSTRACT

A tubular element for transporting a refrigerant fluid between two components of an air-conditioning circuit, said element being a one-piece tube, wherein the tube is a single-layer tube of plastics or thermoplastic material.

The invention relates to a tubular element for an air-conditioning circuit for a motor vehicle, for example.

### BACKGROUND OF THE INVENTION

An air-conditioning circuit is a closed circuit comprising a plurality of elements, in particular a compressor, a condenser, an accumulator, an expander system, and an evaporator, with a refrigerant fluid that circulates around the circuit. All of the elements are interconnected by hoses constituted by flexible and/or rigid tubular elements, and each presenting a fastener element towards each of its ends, and means for leaktight coupling. The elements of an air-conditioning circuit are distributed inside the vehicle engine compartment, it being understood that the compressor is driven by the vehicle engine shaft, whereas the other elements are attached to the bodywork of the vehicle. An air-conditioning circuit of that type can be subdivided into a low-pressure portion and a high-pressure portion, comprising in particular the condenser and the expander system, together with the hoses interconnecting them. This “high-pressure” hose conveying refrigerant fluid at a pressure of about 20 bars is constituted by an assembly of flexible and rigid tubular elements, the flexible tubular portions facilitating assembly on a manufacturing line to some extent since they can deform to follow the path that the hose is to follow in order to connect the condenser and the expander system together.

For an air-conditioning circuit having a temperature regulation valve, the high-pressure portion includes an additional element known as an accumulator or a receiver/dryer which is interposed between the condenser and the evaporator, thereby requiring the presence of two high-pressure hoses between these elements.

Thus, a prior art high-pressure hose requires at least one rigid tubular element and at least one flexible tubular element to be connected together, where such connection can be performed by an operation of crimping the rigid tubular element onto the flexible tubular element. That type of connection can lead to refrigerant fluid leakage, locally increases the size of the high-pressure hose, and leads to a flow constriction for the refrigerant fluid.

### OBJECTS AND SUMMARY OF THE INVENTION

An object of the invention is to mitigate the drawbacks of a prior art high-pressure hose.

To this end, the invention provides a tubular element for transporting a refrigerant fluid between two components of an air-conditioning circuit, said element being a one-piece tube, wherein the tube is a single-layer tube of plastics or thermoplastic material.

Advantageously, the tubular element is made of a thermoplastic material such as a polyamide, in particular a polyamide 6-6, and presents a certain amount of flexibility.

In general, the tubular element is made by extrusion and is shaped into a three-dimensional configuration depending on the path it is to follow once in place.

In an embodiment, the tubular element includes, at least towards each of its two ends, respective fastener elements made out of an optionally-filled plastics material, and leaktight coupling means, each fastener element being suitable for being secured to the tubular element by a suitable operation, such as a rotary welding operation, for example.

A one-piece and single-layer tubular element of the invention presents numerous advantages compared with a prior art solution where the tubular element is constituted in particular by at least one rigid tubular element that needs to be connected to at least one flexible tubular element.

Amongst the advantages, mention can be made in particular of the elimination of crimped connections between the rigid and flexible tubular elements, where such connections can be sources of refrigerant fluid leakage, a weight saving that can be estimated as being about 50%, elimination of flow constrictions between the rigid and flexible tubular elements, an increase in compactness, the elimination of any potential pollution added during the stage when the connections are made, and the possibility of optimizing the inside diameter and the thickness of these tubular elements, where such optimization is not possible with prior art high-pressure hoses for economic reasons, since purchasing volumes are too small for it to be possible to obtain rigid tubular elements from suppliers having as many different sizes as might be desirable.

The invention also provides an air-conditioning circuit comprising a set of flexible and rigid tubular elements for conveying a refrigerant fluid between the various components of the circuit, wherein at least two components of said circuit are connected together by a tubular element in accordance with the invention, the two circuit components being situated in particular in the high-pressure portion of the circuit.

### BRIEF DESCRIPTION OF THE DRAWINGS

Other advantages, characteristics, and details of the invention appear from the additional description below made with reference to the accompanying drawings that are given purely by way of example, and in which:

FIG. 1 is a diagrammatic view showing an air-conditioning circuit in a motor vehicle, the circuit comprising a high-pressure portion and a low-pressure portion;

FIG. 2 is a perspective view of a prior art air-conditioning hose which is mounted in the high-pressure portion of the FIG. 1 air-conditioning circuit;

FIG. 3 is a perspective view of an air-conditioning hose of the invention suitable for replacing the FIG. 2 hose;

FIG. 4 is a section view on line IV-IV of FIG. 3; and

FIG. 5 is a perspective view of a fastening element as mounted at each end of the air-conditioning hose of the invention.

### MORE DETAILED DESCRIPTION

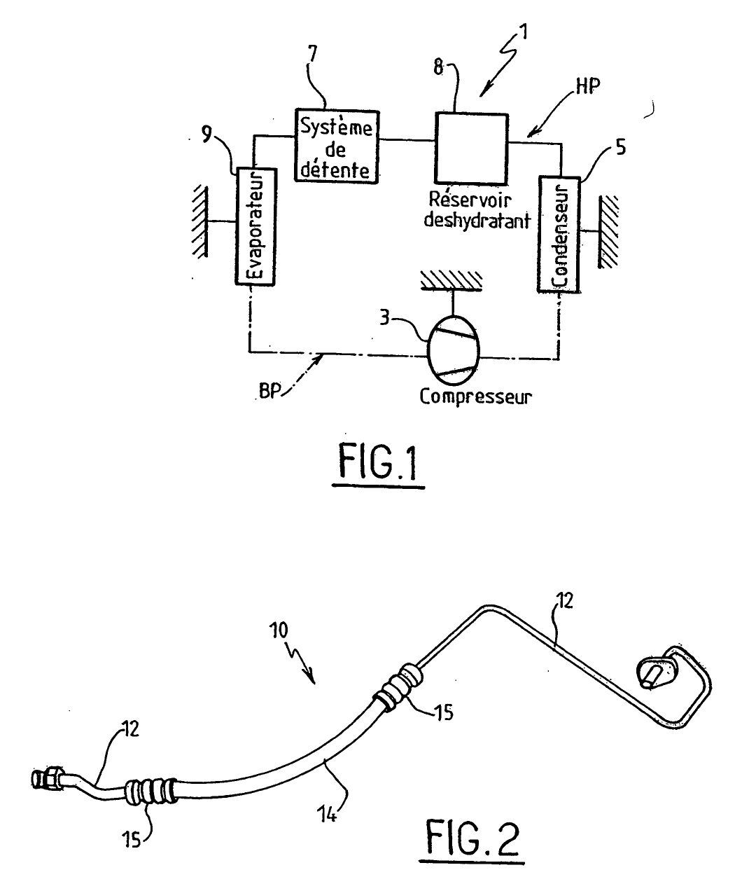

FIG. 1 is a diagram showing an embodiment of an air-conditioning circuit 1 for a motor vehicle, for example. This air-conditioning circuit 1 is a closed circuit comprising a compressor 3 which is driven by the engine shaft of the vehicle, a condenser 5, an expander system 7, a receiver/dryer 8, and an evaporator 9. In the air-conditioning circuit, there is a low-pressure portion LP, and a high-pressure portion HP situated between the compressor 3 and the expansion system 7 in which the refrigerant fluid, in particular R134A, is at a temperature of abut 100° C. and at a pressure of about 20 bars.

The various elements of this air-conditioning circuit 1 are interconnected by hoses, each of which is constituted by a flexible or rigid tubular element having connection means at both ends, or by an appropriate combination of flexible and rigid elements.

FIG. 2 shows a prior art hose 10 which is mounted in the high-pressure portion HP of the air-conditioning circuit, this hose 10 being made up of two rigid tubular elements 12 having a flexible tubular element 14 connected between them by crimping in order to give the hose 10 the desired degree of flexibility. The crimping is referenced 15.

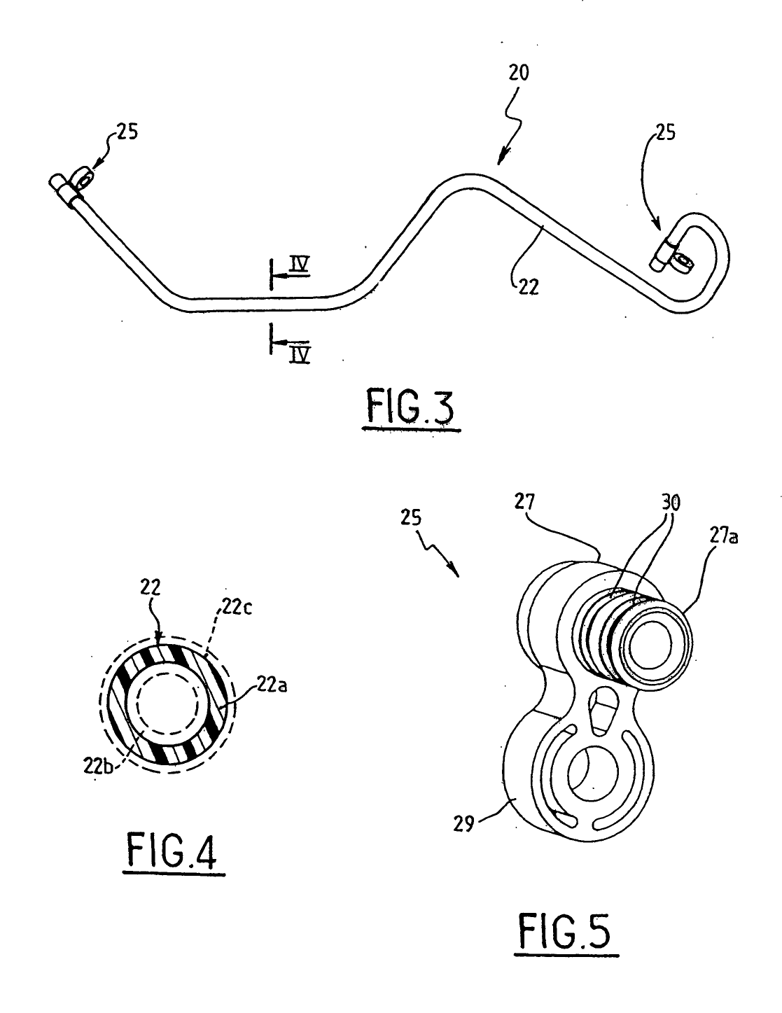

A hose 20 of the invention for taking the place of the FIG. 2 hose 10 is shown in FIGS. 3 and 4. This hose 20 is constituted by a tubular element 22 implemented in the form of a single-layer tube of plastics material that presents a degree of flexibility. The plastics material may be thermoplastic material such as a polyamide, in particular a polyamide 6-6.

The tubular element 22 is made by extrusion and is subsequently shaped to take up a three-dimensional configuration depending on the path that it is to follow. The length of the tubular element 22 can vary, it being understood that its inside diameter may be of the order of 4 millimeters (mm) to 12 mm, e.g. being 7 mm, and its wall thickness being of the order of 0.8 mm to 3 mm, e.g. being 2 mm.

The tubular element 22 is a tube presenting only one layer, but it could optionally be a multilayer tube, as represented in dashed lines in FIG. 4. In which case, the tubular element 22 may present a main layer 22a, and an inner layer 22b and/or an outer layer 22c which are likewise made of a flexible material, e.g. polyamide 6.

The hose 20 also includes, at each of its two ends, a example fastener element 25, advantageously formed as a single piece, e.g. a flange which is advantageously made of a plastics material which is optionally filled in order to obtain greater rigidity. An embodiment of such a fastener element is shown in FIG. 5 and it is H-shaped, e.g. having a right section comprising two tubular portions 27 and 29. The tubular portion 27 is fixed to the tubular element 22 towards one thereof and is extended axially by a tubular portion 27a, whereas the tubular portion 29 is suitable for receiving fastener means such as a screw, for example. The tubular portion 27a is a portion of tube suitable for forming leaktight connection means with the element to which the tubular element 22 is to be connected, having two peripheral grooves 30, each of which can receive an O-ring (not shown). The leaktight connection means could be designed in some other way, and the sealing gaskets need not necessarily be O-rings.

In general, the fastener element 25 is secured to the tubular element 22 by an appropriate operation such as a rotary welding operation, it being understood that such connection can be obtained by other conventional means, e.g. with adhesive.

The tubular element 22 of the invention and as shown in FIG. 3 may also be used in the low-pressure circuit LP of the air-conditioning circuit of FIG. 1. The tubular element 22 may have an inside diameter lying in the range 10 mm to 15 mm, and a wall thickness of about 0.7 mm to 3 mm. In other words, in accordance with the invention, it is possible to devise an air-conditioning circuit in which all of the connecting hoses are constituted by respective tubular elements 22.

By way of example, the permeability of a single-layer tubular element 22 having a wall thickness of about 2 mm with respect to a refrigerant fluid such as R134A is of the order of 11.0 grams per square meter per 72-hour period (g/m²/72 h) at a pressure of 27.5 bars and at a temperature of 100° C.

1. A tubular element for transporting a refrigerant fluid between two components of an air-conditioning circuit, said element being a one-piece tube, wherein the tube is a single-layer tube of plastics or thermoplastic material.

2. A tubular element according to claim 1, in which the layer of said tube is made of polyamide 6-6.

3. A tubular element according to claim 1, in which said tube is made by extrusion and is shaped to take up a three-dimensional configuration corresponding to the path it is to follow once it has been put into place.

4. A tubular element according to claim 1, in which said tube comprises a fastener element at least in the vicinity of each of its two ends, the fastener element being made of an optionally-filled plastics material.

5. A tubular element according to claim 4, in which each fastener element is a single piece and is secured to said tube.

6. A tubular element according to claim 5, in which each fastener element is secured to the tube by a rotary welding operation.

7. A tubular element according to claim 4, in which each fastener element is made of fiberglass-filled polyamide 6-6.

8. An air-conditioning circuit including a set of flexible and rigid tubular elements for conveying a refrigerant fluid between the various components of the circuit, wherein at least two components of said circuit are interconnected by a single-layer tubular element for transporting the refrigerant fluid between said components, said element being a one-piece tube, wherein the tube is a single-layer tube of plastics or thermoplastic material.

9. An air-conditioning circuit according to claim 8, comprising a high-pressure portion and a low-pressure portion, in which the single-layer tubular element is mounted between at least two components of the high-pressure or the low-pressure portion of the circuit.

10. An air-conditioning circuit, wherein all of the components of the circuit are interconnected by single-layer tubular elements for transporting a refrigerant fluid between the components, said element being a one-piece tube, wherein the tube is a single-layer tube of plastics or thermoplastic material.
